(19) United States
(12) Patent Application Publication
(10) Pub. No.: US 2016/0062258 A1
(43) Pub. Date: Mar. 3, 2016

(54) ELECTROPHOTOGRAPHIC PRINTING

(71) Applicant: HEWLETT-PACKARD INDIGO B.V., XR Amstelveen (NL)

(72) Inventors: Haim Cohen, Modiin (IL); Albert Teishev, Rishon le-zion (IL); Ilanit Mor, Kiryat Ono (IL); Nurit Carmel-Barnea, Ness Ziona (IL); Itamar Sela, Ness Ziona (IL)

(21) Appl. No.: 14/787,330

(22) PCT Filed: Jul. 5, 2013
(86) PCT No.: PCT/EP2013/064254

§ 371 Date: Oct. 27, 2015

(51) Int. Cl. G03G 9/12; G03G 13/10; G03G 13/16; G03G 9/13

(52) U.S. Cl. CPC G03G 9/12; G03G 9/131; G03G 13/10; G03G 13/16

(57) ABSTRACT

The present disclosure relates to a liquid electrophotographic ink composition comprising clay platelets. Also disclosed herein is a method for electrophotographic printing, and a print substrate.

### BACKGROUND

Electrophotographic printing processes typically involve creating an image on a photoconductive surface, applying an ink having charged particles to the photoconductive surface, such that they selectively bind to the image, and then transferring the charged particles in the form of the image to a print substrate.

The photoconductive surface is typically on a cylinder and is often termed a photo imaging plate (PIP). The photoconductive surface is selectively charged with a latent electrostatic image having image and background areas with different potentials. For example, an electrophotographic ink composition including charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, more commonly, by being first transferred to an intermediate transfer member, which can be a soft swelling blanket, and then to the print substrate.

### BRIEF DESCRIPTION OF THE FIGURES

FIGS. 1 and 2 show peeling test results for Example 1 described herein.

FIGS. 3 to 6 and 18 show peeling test results for Example 2.

FIG. 7 shows the peeling test results for Example 3.

FIG. 8 show peeling test results for ink C3 of Example 1 printed on various print substrates (see legend of this graph in the Figure).

FIGS. 9 and 10 show scratch resistance test results for Example 6.

FIGS. 11 to 14 show peeling test results for Example 7.

FIGS. 15 to 17 show peeling test results for Example 9.

FIGS. 19 and 20 show flaking test results for Example 8.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier liquid,” “carrier,” or “carrier vehicle” refers to the fluid in which the polymers, particles, colorant, charge directors and other additives can be dispersed to form a liquid electrostatic ink or electrophotographic ink. The carrier liquids may include a mixture of a variety of different agents, such as surfactants, co-solvents, viscosity modifiers, and/or other possible ingredients.

As used herein, “electrophotographic ink composition”, which may be termed an “electrostatic ink composition”, generally refers to an ink composition, which may be in liquid or powder form, that is typically suitable for use in an electrostatic printing process, sometimes termed an electrophotographic printing process. The electrostatic ink composition may include chargeable particles of a resin, which may be as described herein, dispersed in a carrier liquid, which may be as described herein.

As used herein, “pigment” generally includes pigment colorants, magnetic particles, aluminas, silicas, and/or other ceramics or organo-metallics, whether or not such particulates impart color. Thus, though the present description exemplifies, in some examples, the use of pigment colorants, the term “pigment” can be used more generally to describe not just pigment colorants, but other pigments such as organometallics, ferrites, ceramics, etc.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the electrophotographic ink composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate. If the melt viscosity of a particular polymer is specified, unless otherwise stated, it is the melt viscosity for that polymer alone, in the absence of any of the other components of the electrophotographic ink composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrophotographic printing process may involve subjecting the electrophotographic ink composition to an electric field, e.g. an electric field having a field gradient of 50-400 V/μm, or more, ins some examples 600-900 V/μm, or more.

As used herein, “substituted” may indicate that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, thioaryl, etc.

As used herein, “heteroatom” may refer to nitrogen, oxygen, halogens, phosphorus, or sulfur.

As used herein, “alkyl”, or similar expressions such as “alk” in alkaryl, may refer to a branched, unbranched, or cyclic saturated hydrocarbon group, which may, in some examples, contain from 1 to about 50 carbon atoms, or 1 to about 40 carbon atoms, or 1 to about 30 carbon atoms, or 1 to about 10 carbon atoms, or 1 to about 5 carbon atoms for example.

The term “aryl” may refer to a group containing a single aromatic ring or multiple aromatic rings that are fused together, directly linked, or indirectly linked (such that the different aromatic rings are bound to a common group such as a methylene or ethylene moiety). Aryl groups described herein may contain, but are not limited to, from 5 to about 50 carbon atoms, or 5 to about 40 carbon atoms, or 5 to 30 carbon atoms or more, and may be selected from, phenyl and naphthyl.

As used herein, the term “about” is used to provide flexibility to a numerical range endpoint by providing that a given value may be a little above or a little below the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

In an aspect, there is provided a liquid electrophotographic ink composition including clay platelets.

In an aspect, there is provided a method for electrophotographic printing, the method involving
forming a latent electrostatic image on a surface;
contacting the surface with a liquid electrophotographic ink composition including clay platelets to form a developed toner image on the surface, and transferring the toner image to a print substrate.

In an aspect, there is provided a print substrate having printed thereon an ink including a resin having acidic side groups and clay platelets.

It has been found that some electrophotographic inks in the prior art did not have desired durability, e.g. in peel, scratch, flaking, or rub tests, when printed on certain print substrates. In the prior art, this has sometimes been addressed by adding certain polymeric substances to the inks, e.g. waxes, to try to increase their durability, or by applying a varnish to the inks. It has been found that by including clay platelets in the electrophotographic inks that adhesion to a print substrate can be increased, without having to include other additives or applying varnishes over the printed ink.

In some examples, at least some of the clay platelets have a maximum dimension of about 50 μm or less. In some examples, at least some of the clay platelets have a maximum dimension of about 10 μm or less. Maximum dimension is the largest dimension that can be measured across a platelet particle. The dimension may be measured, for example, using a scanning electron micrograph or other techniques.

In the present application, a platelet may have a three dimensional shape with a first dimension, which may be termed a thickness, less than the other two dimensions, each of which are perpendicular to one another and to the first dimension. In some examples, at least some of the platelets have a thickness of at least 0.01 nm, in some examples a thickness of at least 0.05 nm, in some examples a thickness of at least 0.1 nm, in some examples a thickness of at least 0.5 nm, in some examples a thickness of at least 1 nm. In some examples, at least some of the platelets have a thickness of 100 nm or less, in some examples a thickness of 50 nm or less, in some examples a thickness of 20 nm or less, in some examples a thickness of 10 nm or less, in some examples a thickness of 5 nm or less, in some examples a thickness of 3 nm or less, in some examples a thickness of 2 nm or less.

In some examples, at least some of the platelets have a diameter, measured in a direction perpendicular to the thickness and excluding any coating on the platelet, of at least 10 nm, in some examples a diameter of at least 20 nm, in some examples a diameter of at least 50 nm, in some examples a diameter of at least 70 nm, in some examples a diameter of at least 90 nm, in some examples a diameter of at least 100 nm. In some examples, at least some of the platelets have a diameter, measured in a direction perpendicular to the thickness, of 500 nm or less, in some examples a diameter of 300 nm or less, in some examples a diameter of 200 nm or less, in some examples a diameter of 150 nm or less, in some examples a diameter of 120 nm or less.

In some examples, at least some of the platelets have an aspect ratio of a diameter (measured in a direction perpendicular to the thickness) to its thickness of n:1, where n is at least 2, in some examples at least 5, in some examples at least 10, in some examples at least 20, in some examples at least 30, in some examples at least 50, in some examples at least 70, in some examples at least 80, in some examples at least 100. In some examples, at least some of the platelets have an aspect ratio of a diameter (measured in a direction perpendicular to the thickness) to its thickness of n:1, where n is 1000 or less, in some examples n is 500 or less, in some examples n is 200 or less, in some examples n is 60 or less, in some examples n is 150 or less.

In some examples, at least some of the clay platelets have a maximum dimension of about 50 μm or less.

In some examples, at least some of the clay platelets have a maximum dimension of about 10 μm or less.

The clay platelets may include, consist essentially of or consist of a clay material. Consist essentially of in this context may indicate that the clay platelets include at least 95 wt % clay material, in some examples at least 98 wt % clay material, in some examples at least 99 wt % clay material. In some examples, the clay platelets include a clay material selected from montmorillonite, kaolinite, halloysite, illite, vermiculite, talc, palygorskite and pyrophyllite. The clay material, which may be modified as described below, or may be uncoated before incorporation into the ink. In some examples, the clay material is selected from montmorillonite and kaolinite. Montmorillonite clay material has been found to increase flaking and peeling resistance of the inks, although in certain circumstances it may have a negative effect on the scratch resistance of the inks. Kaolinite seems to increase flaking and peeling resistance of the inks and generally no negative effect has been observed on the scratch or rub resistance.

In some examples, the clay material has been modified with a quaternary ammonium salt. In some examples, the quaternary ammonium salt has a group including a C10 to C20 alkyl or alkylene group, in some examples a C12 to C18 alkyl or alkylene group. In some examples, the quaternary ammonium salt has been modified with a hydrogenated tallow or tallow moiety.

In some examples, the clay platelets constitute from about 1 wt % to about 10 wt % of the solids of the liquid electrophotographic ink composition.

In some examples the clay platelets constitute from about 3 wt % to about 7 wt %, in some examples 4 wt % to 6 wt %, in some examples about 5 wt %, of the solids of the liquid electrophotographic ink composition.

In some examples the ink includes particles including a resin having acidic side chains.

In some examples, the ink includes particles includes a resin including a polymer selected from (i) ethylene or propylene acrylic acid co-polymers and (ii) ethylene or propylene methacrylic acid co-polymers.

Before application to the print substrate in the electrophotographic printing process, the electrophotographic ink composition may be in liquid form; and may include a carrier liquid in which is suspended particles of a thermoplastic resin and the clay platelets. Generally, the carrier liquid can act as a dispersing medium for the other components in the electrophotographic ink composition. For example, the carrier liquid can include or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In particular, the carrier liquids can include, but are not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

The carrier liquid can constitute about 20% to 99.5% by weight of the electrophotographic ink composition, in some examples 50% to 99.5% by weight of the electrophotographic ink composition. The carrier liquid may constitute about 40 to 90% by weight of the electrophotographic ink composition. The carrier liquid may constitute about 60% to 80% by weight of the electrophotographic ink composition. The carrier liquid may constitute about 90% to 99.5% by weight of the electrophotographic ink composition, in some examples 95% to 99% by weight of the electrophotographic ink composition.

The ink when printed on the print substrate may be substantially free from carrier liquid. In an electrophotographic printing process and/or afterwards, the carrier liquid may be removed, e.g. by an electrophoresis processes during printing and/or evaporation, such that substantially just solids are transferred to the print substrate. Substantially free from carrier liquid may indicate that the ink printed on the print substrate contains less than 5 wt % carrier liquid, in some examples, less than 2 wt % carrier liquid, in some examples less than 1 wt % carrier liquid, in some examples less than 0.5 wt % carrier liquid. In some examples, the ink printed on the print substrate is free from carrier liquid.

The electrophotographic ink composition and/or the ink printed on the print substrate can include a thermoplastic resin, which will for brevity be termed a ‘resin’ herein. The resin may be a resin having acidic side groups. A thermoplastic polymer is sometimes referred to as a thermoplastic resin. In some examples, the polymer of the resin may be selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %), and alkyl (e.g. C1 to C5) ester of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may be or include a polymer having acidic side groups. Examples of the polymer having acidic side groups will now be described. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may include a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN® ionomers. The polymer including acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may include two different polymers having acidic side groups. The two polymers having acidic side groups may have different acidities, which may fall within the ranges mentioned above. The resin may include a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may include two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may include a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may include a first polymer having a melt viscosity of 15000 poise or more, in some examples 20000 poise or more, in some examples 50000 poise or more, in some examples 70000 poise or more; and in some examples, the resin may include a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may include a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin in electrophotographic ink or ink composition includes a single type of polymer, the polymer (excluding any other components of the electrophotographic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin includes a plurality of polymers all the polymers of the resin may together form a mixture (excluding any other components of the electrophotographic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may include two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN® ionomers. The resin may include (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt % to about 16 wt % of the co-polymer, in some examples 10 wt % to 16 wt % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt % to about 30 wt % of the co-polymer, in some examples from 14 wt % to about 20 wt % of the co-polymer, in some examples from 16 wt % to about 20 wt % of the co-polymer in some examples from 17 wt % to 19 wt % of the co-polymer.

The resin may include a polymer having acidic side groups, as described above (which may be free of ester side groups), and a polymer having ester side groups. The polymer having ester side groups may be a thermoplastic polymer. The polymer having ester side groups may further include acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. thermoplastic resin polymers, in the electrophotographic ink composition and/or the ink printed on the print substrate, e.g. the total amount of the polymer or polymers having acidic side groups and polymer having ester side groups. The polymer having ester side groups may constitute 5% or more by weight of the total amount of the resin polymers, e.g. thermoplastic resin polymers, in some examples 8% or more by weight of the total amount of the resin polymers, e.g. thermoplastic resin polymers, in some examples 10% or more by weight of the total amount of the resin polymers, e.g. thermoplastic resin polymers, in some examples 15% or more by weight of the total amount of the resin polymers, e.g. thermoplastic resin polymers, in some examples 20% or more by weight of the total amount of the resin polymers, e.g. thermoplastic resin polymers, in some examples 25% or more by weight of the total amount of the resin polymers, e.g. thermoplastic resin polymers, in some examples 30% or more by weight of the total amount of the resin polymers, e.g. thermoplastic resin polymers, in some examples 35% or more by weight of the total amount of the resin polymers, e.g. thermoplastic resin polymers, in the electrophotographic ink composition and/or the ink printed on the print substrate. The polymer having ester side groups may constitute from 5% to 50% by weight of the total amount of the resin polymers, e.g. thermoplastic resin polymers, in the electrophotographic ink composition and/or the ink printed on the print substrate, in some examples 10% to 40% by weight of the total amount of the resin polymers, e.g. thermoplastic resin polymers, in the electrophotographic ink composition and/or the ink printed on the print substrate, in some examples 5% to 30% by weight of the total amount of the resin polymers, e.g. thermoplastic resin polymers, in the electrophotographic ink composition and/or the ink printed on the print substrate, in some examples 5% to 15% by weight of the total amount of the resin polymers, e.g. thermoplastic resin polymers, in the electrophotographic ink composition and/or the ink printed on the print substrate in some examples 15% to 30% by weight of the total amount of the resin polymers, e.g. thermoplastic resin polymers, in the electrophotographic ink composition and/or the ink printed on the print substrate.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™ Nucrel 910™, Nucrel 925™, Nucrel 699™, Nucrel 599™ Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

The resin can constitute about 5 to 90%, in some examples about 50 to 80%, by weight of the solids of the electrophotographic ink composition and/or the ink printed on the print substrate. The resin can constitute about 60 to 95%, in some examples about 70 to 95%, by weight of the solids of the electrophotographic ink composition and/or the ink printed on the print substrate.

The electrophotographic ink composition and/or ink printed on the print substrate can include a charge director. A charge director can be added to an electrophotographic ink composition to impart a charge of a desired polarity and/or maintain sufficient electrophotographic charge on the particles of an electrophotographic ink composition. The charge director may include ionic compounds, including, but not limited to, metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™ and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates (e.g. see WO 2007/130069). The charge director can impart a negative charge or a positive charge on the resin-containing particles of an electrophotographic ink composition.

The charge director can include a sulfosuccinate moiety of the general formula [Rₐ—O—C(O)CH₂CH(SO₃⁻)C(O)—O—R_{b}], where each of Rₐ and R_{b} is an alkyl group. In some examples, the charge director includes nanoparticles of a simple salt and a sulfosuccinate salt of the general formula MAₙ, wherein M is a metal, n is the valence of M, and A is an ion of the general formula [Rₐ—O—C(O)CH₂CH(SO₃⁻)C(O)—O—R_{b}], where each of Rₐ and R_{b} is an alkyl group, or other charge directors as found in WO2007130069, which is incorporation herein by reference in its entirety. As described in WO2007130069, the sulfosuccinate salt of the general formula MAₙ is an example of a micelle forming salt. The charge director may be substantially free or free of an acid of the general formula HA, where A is as described above. The charge director may include micelles of said sulfosuccinate salt enclosing at least some of the nanoparticles. The charge director may include at least some nanoparticles having a size of 200 nm or less, in some examples 2 nm or more. As described in WO2007130069, simple salts are salts that do not form micelles by themselves, although they may form a core for micelles with a micelle forming salt. The ions constructing the simple salts are all hydrophilic. The simple salt may include a cation selected from Mg, Ca, Ba, NH₄, tert-butyl ammonium, Li⁺, and Al⁺³, or from any sub-group thereof. The simple salt may include an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. The simple salt may be selected from CaCO₃, Ba₂TiO₃, Al₂(SO₄), A1(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. The charge director may further include basic barium petronate (BBP).

In the formula [Rₐ—O—C(O)CH₂CH(SO₃⁻)C(O)—O—R_{b}], in some examples, each of Rₐ and R_{b} is an aliphatic alkyl group. In some examples, each of Rₐ and R_{b} independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, Rₐ and R_{b} are the same. In some examples, at least one of Rₐ and R_{b} is C₁₃H₂₇. In some examples, M is Na, K, Cs, Ca, or Ba. The formula [Rₐ—O—C(O)CH₂CH(SO₃⁻)C(O)—O—R_{b}] and/or the formula MAₙ may be as defined in any part of WO2007130069.

The charge director may include (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In an electrophotographic ink composition, the charge director can constitute about 0.001% to 20%, in some examples 0.01 to 20% by weight, in some examples 0.01 to 10% by weight, in some examples 0.01 to 1% by weight of the solids of the electrophotographic ink composition and/or ink printed on the print substrate. The charge director can constitute about 0.001 to 0.15% by weight of the solids of the electrophotographic ink composition and/or ink printed on the print substrate, in some examples 0.001 to 0.15%, in some examples 0.001 to 0.02% by weight of the solids of the electrophotographic ink composition and/or ink printed on the print substrate. In some examples, the charge director imparts a negative charge on the electrophotographic ink composition. The particle conductivity may range from 50 to 500 pmho/cm, in some examples from 200-350 pmho/cm.

The electrophotographic ink composition and/or ink printed on the print substrate can include a charge adjuvant. A charge adjuvant may be present with a charge director, and may be different to the charge director, and act to increase and/or stabilise the charge on particles, e.g. resin-containing particles, of an electrophotographic ink composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant can constitute about 0.1 to 5% by weight of the solids of the electrophotographic ink composition and/or ink printed on the print substrate. The charge adjuvant can constitute about 0.5 to 4% by weight of the solids of the electrophotographic ink composition and/or ink printed on the print substrate. The charge adjuvant can constitute about 1 to 3% by weight of the solids of the electrophotographic ink composition and/or ink printed on the print substrate.

The electrophotographic ink composition and/or ink printed on the print substrate may further include a colorant. The colorant may be selected from a pigment, dye and a combination thereof. The colorant may be transparent, unicolor or composed of any combination of available colors. The colorant may be selected from a cyan colorant, a yellow colorant, a magenta colorant and a black colorant. The electrophotographic ink composition and/or ink printed on the print substrate may include a plurality of colorants. The electrophotographic ink composition and/or ink printed on the print substrate may include a first colorant and second colorant, which are different from one another. Further colorants may also be present with the first and second colorants. The electrophotographic ink composition and/or ink printed on the print substrate may include first and second colorants where each is independently selected from a cyan colorant, a yellow colorant, a magenta colorant and a black colorant. In some examples, the first colorant includes a black colorant, and the second colorant includes a non-black colorant, for example a colorant selected from a cyan colorant, a yellow colorant and a magenta colorant. The colorant may be selected from a phthalocyanine colorant, an indigold colorant, an indanthrone colorant, a monoazo colorant, a diazo colorant, inorganic salts and complexes, dioxazine colorant, perylene colorant, anthraquinone colorants, and any combination thereof.

In some examples, the electrophotographic printing process may involve providing the ink in the form of an electrophotographic ink composition including particles including the thermoplastic resin and the clay platelets and, in some examples, a pigment, which may be dispersed in a liquid carrier, the method involving:
forming a latent electrostatic image on a surface;
contacting the surface with the electrophotographic ink composition, such that at least some of the particles adhere to the surface to form a developed toner image on the surface, and transferring the toner image to the print substrate. In some examples, the particles include both the resin and the clay platelets.

The surface on which the latent electrostatic image is formed may be on a rotating member, e.g. in the form of a cylinder. The surface on which the latent electrostatic image is formed may form part of a photo imaging plate (PIP). The contacting may involve passing the electrophotographic ink composition between a stationary electrode and a rotating member, which may be a member having the surface having a latent electrostatic image thereon or a member in contact with the surface having a latent electrostatic image thereon. A voltage is applied between the stationary electrode and the rotating member, such that the particles adhere to the surface of the rotating member. This may involve subjecting the electrophotographic ink composition to an electric field having a field gradient of 50-400 V/μm, or more, in some examples 600-900 V/μm, or more.

The intermediate transfer member may be a rotating flexible member, which is in some examples heated, e.g. to a temperature of from 80 to 160° C., in some examples from 90 to 130° C., in some examples from 100 to 110° C.

Also provided herein is a print substrate having printed thereon an ink including a resin having acid side groups and clay platelets. In some examples, the resin includes a polymer selected from ethylene or propylene acrylic acid co-polymers and ethylene or propylene methacrylic acid co-polymers; and the print substrate may be producible in or produced in a method as described herein.

The print substrate, before having been printed with the ink, may be any suitable substrate. The print substrate may be any suitable substrate capable of having an image printed thereon. The print substrate may include a material, which may be termed a print material, selected from an organic or inorganic material. The print material may include a natural polymeric material, e.g. cellulose. The print material may include a synthetic polymeric material, e.g. a polymer formed from alkylene monomers, including, but not limited to, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g. a non-cellulosic polymer, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print substrate. In some examples, the substrate is a gloss print substrate, in some examples a gloss paper.

### EXAMPLES

The following illustrates examples of the methods and other aspects described herein. Thus, these Examples should not be considered as limitations of the present disclosure, but are merely in place to teach how to make examples of the present disclosure.

Materials

Clay Materials:

Typically, the clay materials were magnesium aluminum silicates, having particle dimensions of approx 100+nm×100+nm×1 nm. In some examples, the particles had an inner layer of alumina/magnesia, and a silicon dioxide outer layer.

In the Examples below, the following specific clays were used:
Cloisite® 15A/Rockwood [C15]—treated with quaternary ammonium salt which act as surfactant (increase hydrophobicity)
Cloisite® Ca⁺⁺/Rockwood—natural montmorillonite clay
Dixie Clay® /R. T. Vanderbilt—natural kaolin clay (aluminum silicate)

Resins/Other Ink Components:

Resins:

Nucrel 699 [Resin F] from Dupont—copolymer of ethylene and methacrylic acid, made with nominally 11 wt % methacrylic acid

Honeywell AC-5120 [Resin ACE]—Ethylene-Acrylic Acid Copolymer with Acid number of 112-130 KOH/g

Additives:

Zonyl MP 1200 [W12] from Dupont—fluoroadditive PTFE powder designed as a additive in other materials to impart low-surface energy

Acumist B-6 [HPB] from Honeywell—Fine Particle Size Polyethylene Homopolymers

Aerosil R7200 [DS72] from Evonik—structure modified and with a methacrylsilane aftertreated fumed silica

VCA [Sigma Aldrich]—Aluminum stearate as charge adjuvant to capture charge director molecules

Ink Preparation Procedure:

First, a “paste” of molten resins and Isopar was prepared on a laboratory scale “Ross” mixer using a procedure which involved mixing raw material resins and Isopar L. The procedure began with raising the temperature of a mixture of 40% of resin and 60% Isopar to 130° C. (266° F.) in the mixer at a mixing speed of 50 Hz. The resins used were Nucrel 699 and A-C 5120 in the weight ratio of 4:1. After an hour and a half the mixer speed was raised to 70 Hz and the mixture then mixed at this speed for another hour. The next stage involved stopping the heating and reducing the mixer speed back to 50 Hz. This allowed the paste to cool to room temperature. After that, the paste was ground with pigment, Isopar and other additives VCA and DS72. The grinding speed was 250 RPM and the grinding involved two stages, 1.5 hours at 58° C. and another period of 10.5 hours at 37° C. Clay powder was included in grinding unless otherwise indicated. The ink is ready after grinding, and then HPB Slurry (powder ground with Isopar and VCA at 21 wt % NVS) and DS72 added to working dispersion (3 wt % NVS) and solids (10 wt % NVS). NCD is used for ink charging of the working dispersion; NCD indicates a charge director that, before addition to the ink, can include soya lecithin at 6.6% w/w, basic barium petronate BBP at 9.8% w/w, isopropyl amine dodecylebezene sulfonic acid at 3.6% w/w and about 80% w/w isoparaffin (Isopar®-L from Exxon).

Test Methods:

Peeling—job printed at increasing coverage from 100% to 400%. The operator waits 10 min and then applies standard adhesive tape on specific location, then clip the tape with heavy roller (coated with rubber) on top of print. After 10 repetitions operator peel of the tape off image and damage is evaluated by scanning software (ink peeled off).

Scratch—prints of circles at 250% and 400% printed, after two days samples are taken to Taber shear/scratch tester model 551. Tungsten carbide tip is installed to cause damage to print when print is fixed on iron plate. Scratch movement occurs like “phonograph” as circular scratch which evaluated by debris collected and weight, also as visual impression.

Rub—Sutherland ink rub tester used for testing 100% image printed. Sample fixed on elastic surface on bottom and 3M 9μ silica paper clipped to upper weight which placed on print. Then linear movement rubbed the paper over the image 100 times for coated substrate and 25 times for uncoated substrate. Image is evaluated with ColorEye© XTH.

Flaking—Image printed all over substrate at 250% for coated paper with relatively poor adherence to commercially available HP Electroinks (e.g. 4.5) and 350% for coated paper with relatively good adherence to commercially available Electroinks (e.g. 4.5). In this context, relatively poor adherence can indicate that when the ink is printed at 100% coverage, the amount of ink remaining on the paper following a peeling test is considered low (e.g. about 80 wt % or less). In this context, relatively good adherence can indicate that when the ink is printed at 100% coverage, the amount of ink remaining on the paper following a peeling test is considered high (e.g. about 90 wt % or more). Immediately after printing operator clips one paper to standard lab book; another one is fixed on table and both prints been rubbed at rate of 40 cycles per minute for one minute. To analyze the result the bottom page from the test is scanned and software calculate the amount of ink remained on substrate.

### Example 1

### 1^{st} Test—Peeling

4 inks were tested: C REF (the commercially available HP ElectroInk 4.5—Cyan, product number Q4132A, from a large can); C1 internal reference made as described in the Ink Preparation Procedure given above, except without certain additives added to working dispersion and solids (namely without PE wax HPB, PTFE wax W12, and nano silica DS72); C2 tested ink #1 (C1+2.5 wt % Cloisite® 15A); C3 tested ink #2 (C1+5 wt % Cloisite® 15A)

More detail on the inks is given in Table 1 below.

TABLE 1

| Ink | Function | Grinding | Filler | Additives |
|---|---|---|---|---|
| C | Reference | CTR/S200 | w/o | HPB; W12; |
| REF | | | | DS72 |
| C1 | Internal REF | S1 | w/o | None |
| C2 | Tested ink | S1 | 2.5% | None |
| C3 | Tested ink | S1 | 5% | None |

S1 Attritor [Union Process]—lab scale ball grinding tool for ink preparation (1 gallon)

S200 Attritor [Union Process]—Manufacture scale ball grinding tool for ink preparation (313 gallon)

CTR [Union Process]—continuous ball grinding tool for ink preparation (130 gallon)

“Filler” in table 1 indicates the amount of clay platelet material, in terms of % by weight of the solids of the ink; w/o indicates no filler was present.

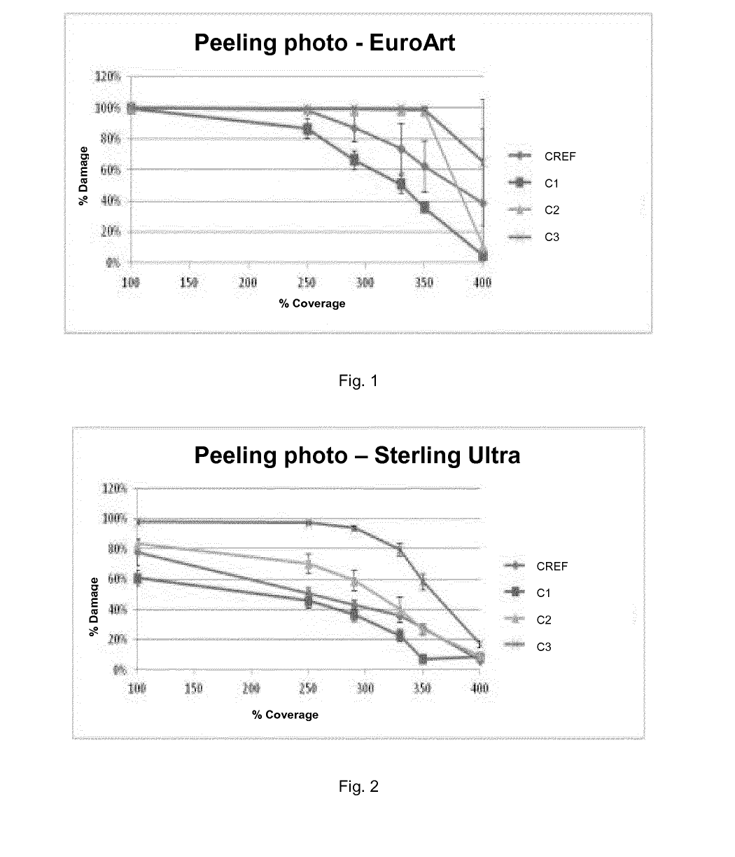

The results for the peeling tests are given in FIGS. 1 and 2, for the print substrates, EuroArt and Sterling Ultra, respectively. The graphs are also supported by samples with clear visible trend which exhibit “on/off” affect. The result hold samples of high coverage without ink on substrate for standard ink, and samples of ink with clay at high coverage with almost all ink on substrate.

### Example 2

### 2^{nd} Test—Peeling

4 inks were tested, first C REF(as Example 1), C1 internal reference with HPB slurry (made as described in the Ink Preparation Procedure given above, except without PTFE wax W12, and nano silica DS72), C2 tested ink #1 (C1+2.5% Cloisite® 15A), C3 tested ink #2 (C1+5% Cloisite® 15A)

More detail on the inks is given in Table 2 below.

TABLE 2

| Ink | Function | Grinding | Filler | Additives |
|---|---|---|---|---|
| C REF | Reference | CTR/S200 | w/o | HPB; W12; |
| | | | | DS72 |
| C1 | Internal REF | S1 | w/o | HPB |
| C2 | Tested ink | S1 | 2.5% | HPB |
| C3 | Tested ink | S1 | 5% | HPB |

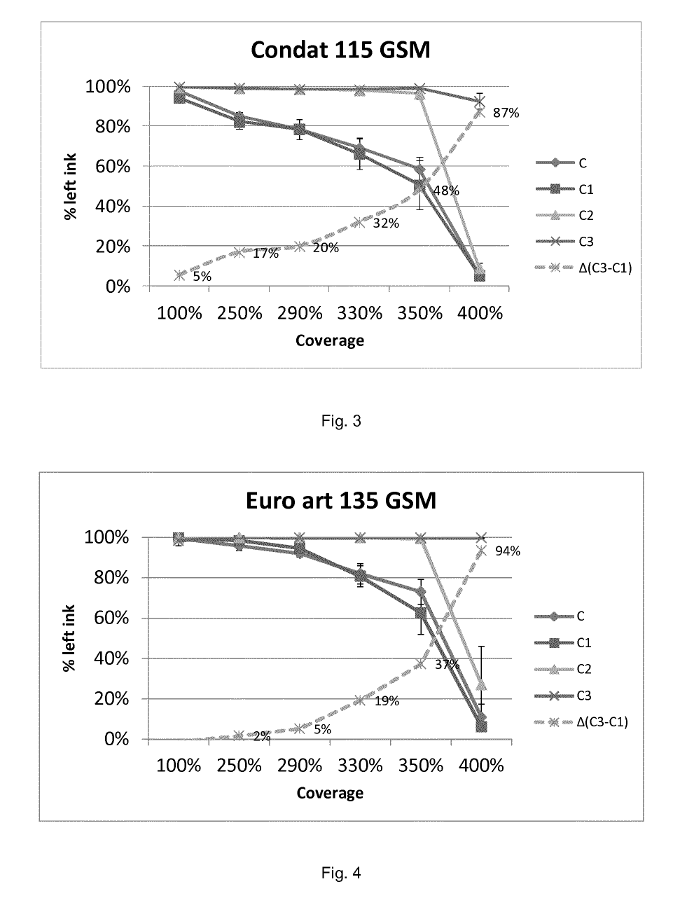

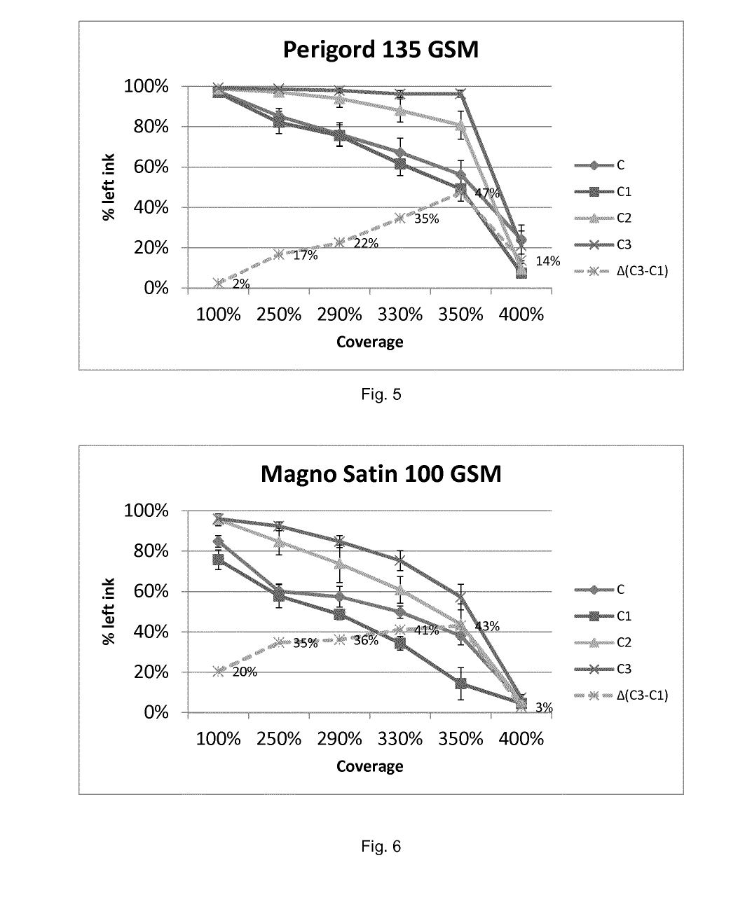

The results for the peeling tests are given in FIGS. 3, 4, 5, 6, and 18 for the print substrates, Condat 115 GSM, Euroart 135 GSM, Perigord 135 GSM and Magno Satin 100 GSM, Sterling Ultra 115 GSM respectively. The graphs are also supported by samples with clear visible trend which exhibit “on/off” affect. The result hold samples of high coverage without ink on substrate for standard ink, and samples of ink with clay at high coverage with almost all ink on substrate.

### Example 3

### 3^{rd} Test—Peeling

The inks from Example 2 were also printed onto an uncoated paper.

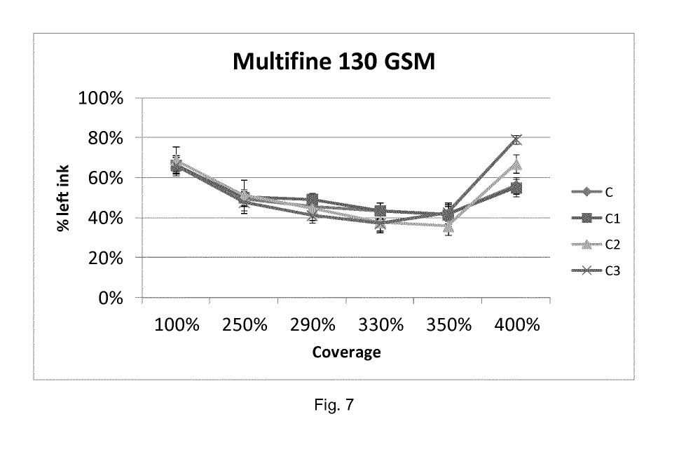

The peeling test results are shown in FIG. 7.

### Example 4

### Consolidated Peeling Test Results for Ink C3

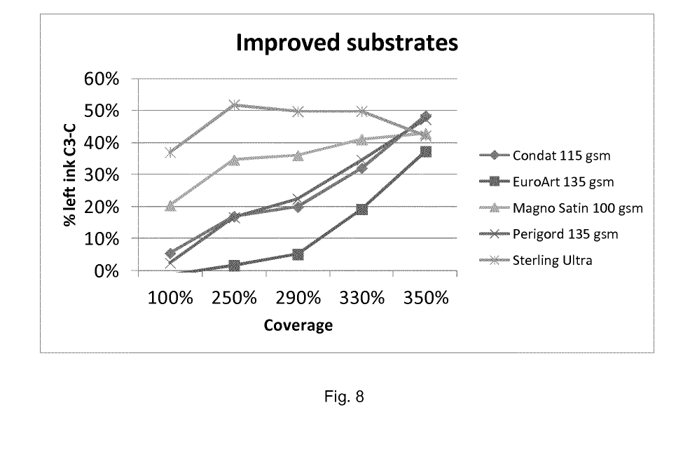

FIG. 8 illustrates the peeling test results for ink C3 of Example 1 printed on various print substrates (see legend of this graph in the Figure).

### Example 5

### Flaking Test Results

Table 3 below illustrates the Flaking Test Results for various inks and print media.

TABLE 3

| | | | % of |
|---|---|---|---|
| Color | Comment | Media | Damage |
| Cyan | C REF | UPM | 0 |
| Cyan | C1 | UPM | 0.631 |
| Cyan | C2 | UPM | 2.077 |
| Cyan | C3 | UPM | 0.562 |
| Cyan | C REF | EA | 0.001 |
| Cyan | C1 | EA | 0.041 |
| Cyan | C2 | EA | 0.026 |
| Cyan | C3 | EA | 0.007 |

### Example 6

### Scratch Resistance Tests

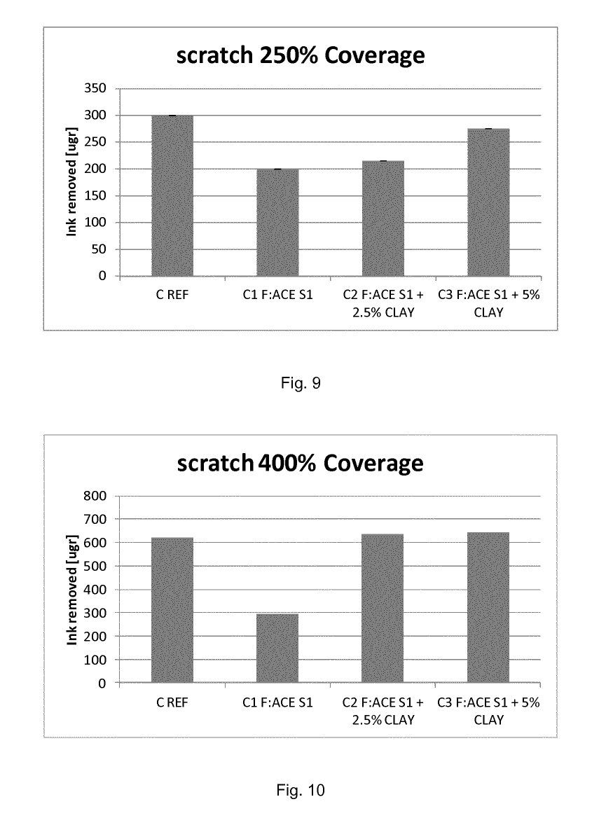

FIGS. 9 and 10 show, respectively, the scratch resistance tests for inks at 250% coverage, and 400% coverage; the inks tests were the reference ink C, and inks C1, C2 and C3 on the print medium of Example 1 for the print media Euroart 135 gsm

### Example 7

4 inks were tested: C REF(as Example 1), C1 internal reference with HPB slurry (made as described in the Ink Preparation Procedure given above, except without nano silicaDS72, PTFE waxW12), C2 tested ink #1 (C1+5% Dixie Clay®), C3 tested ink #2 (C1+5% Cloisite® Ca⁺⁺. Further details are given in Table 4 below.

TABLE 4

| Ink | Function | Grinding | Filler | Additives |
|---|---|---|---|---|
| C REF | Reference | CTR/S200 | w/o | HPB; W12; |
| | | | | DS72 |
| C1 | Internal REF | S1 | w/o | HPB |
| C2 | Tested ink | S1 | 5% | Dixie Clay |
| C3 | Tested ink | S1 | 5% | CLCa⁺⁺ |

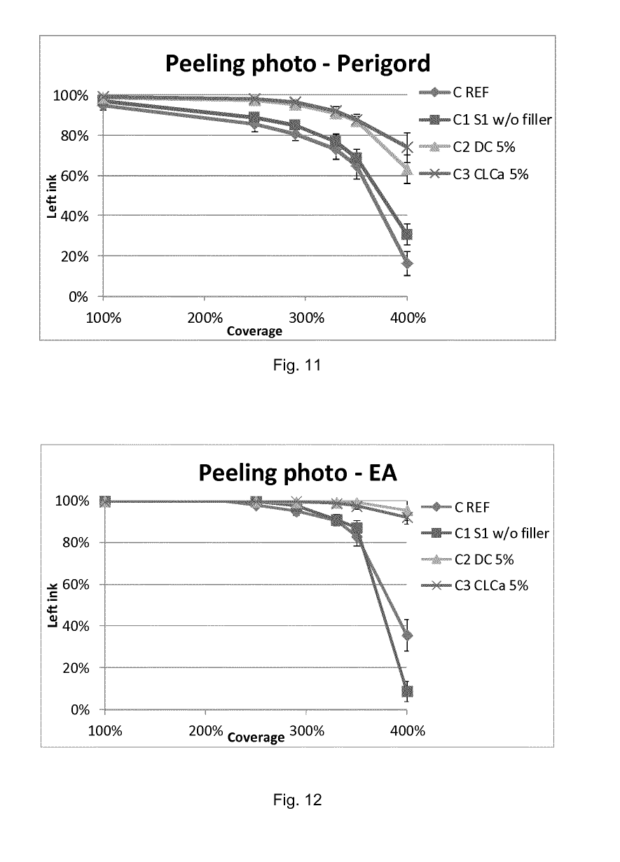

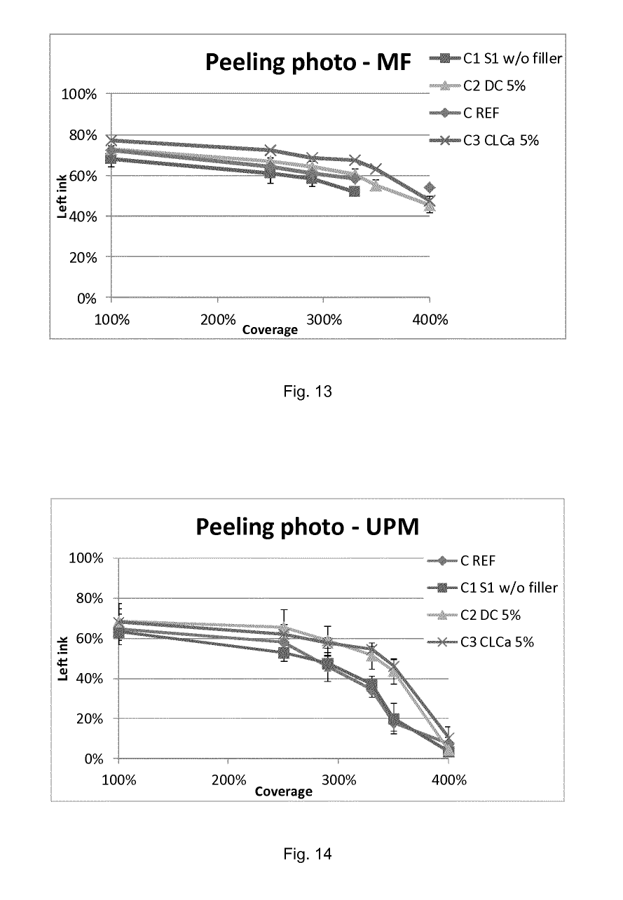

Peeling Test Results are given in FIGS. 11 to 14, respectively, for the following print substrates: Perigord, EuroArt (EA), Multifine (MF), and UPM.

### Example 8

The inks from Example 7 were also printed for flaking Test are shown in Table 5 below on two substrates:
a) Euroart 135 gsm
b) UPM finesse gloss 135 gsm

TABLE 5

| | | | | % of |
|---|---|---|---|---|
| Test Type Name | Page Name | Color | Coverage | Damage |
| NCD+Naturalized | EA_C_ref | Cyan | 350% | 0 |
| CLay | | | | |
| NCD+Naturalized | EA_C1_w/o fillers | Cyan | 350% | 0.036 |
| CLay | | | | |
| NCD+Naturalized | EA_C2_5% DC | Cyan | 350% | 0 |
| CLay | | | | |
| NCD+Naturalized | EA_C3_5% CLCa | Cyan | 350% | 0 |
| CLay | | | | |
| NCD+Naturalized | UPM_C_ref | Cyan | 250% | 0.014 |
| CLay | | | | |
| NCD+Naturalized | UPM_C1_w/o | Cyan | 250% | 0.135 |
| CLay | fillers | | | |
| NCD+Naturalized | EA_C2_5% DC | Cyan | 250% | 0.059 |
| CLay | | | | |
| NCD+Naturalized | UPM_C3_5% CLCa | Cyan | 250% | 0.001 |
| CLay | | | | |

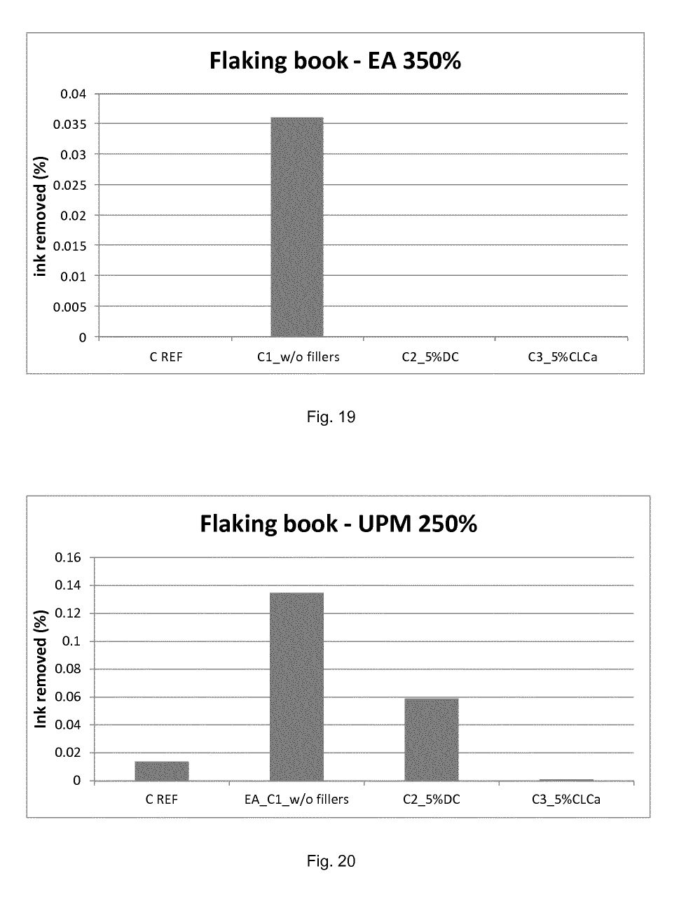

Results are shown in FIGS. 19 to 20, respectively, for the inks on the following print media: EuroArt, and UPM

### Example 9

3 inks were tested, first C1 internal reference (made as described in the Ink Preparation Procedure given above, except without nano silica DS72, PTFE wax W12), C2 tested ink #1 (C1+5% ground slurry* of Cloisite® 15A), C3 tested ink #2 (C1+5% ground slurry* of CLCa⁺⁺®). Further information is given in Table 6 below. *Slurry indicates that powder is ground in Attritor with Isopar (w/o VCA) to smaller (nano sized) particle sizes. The procedure of slurry preparation began with powder and Isopar which are both put into laboratory grind ball mill S-0 (small unit of same supplier Union process, it holds 0.5 litre). Usually cold conditions are kept around 12-20° C. in order to reduce sufficiently the particle size. When slurry is ready it is then ground in the same manner as the powder in Example 1. This involved a change in the form and size of clay particles.

TABLE 6

| Ink | Function | Grinding | Filler | Additives |
|---|---|---|---|---|
| C1 | Reference | S1 | w/o | HPB |
| C2 | Tested ink | S1 | 5% CL15 | HPB |
| | | | slurry | |
| C3 | Tested ink | S1 | 5% CLCa⁺⁺ | HPB |
| | | | slurry | |

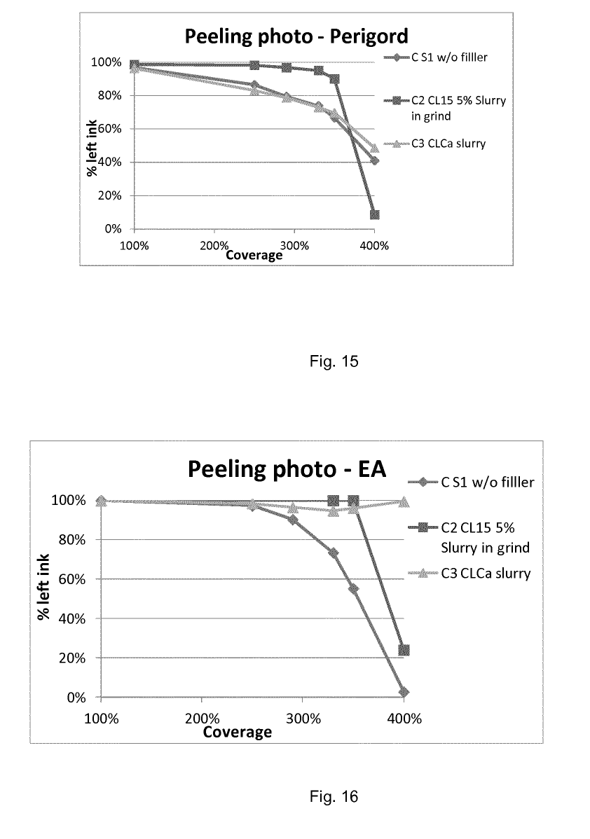

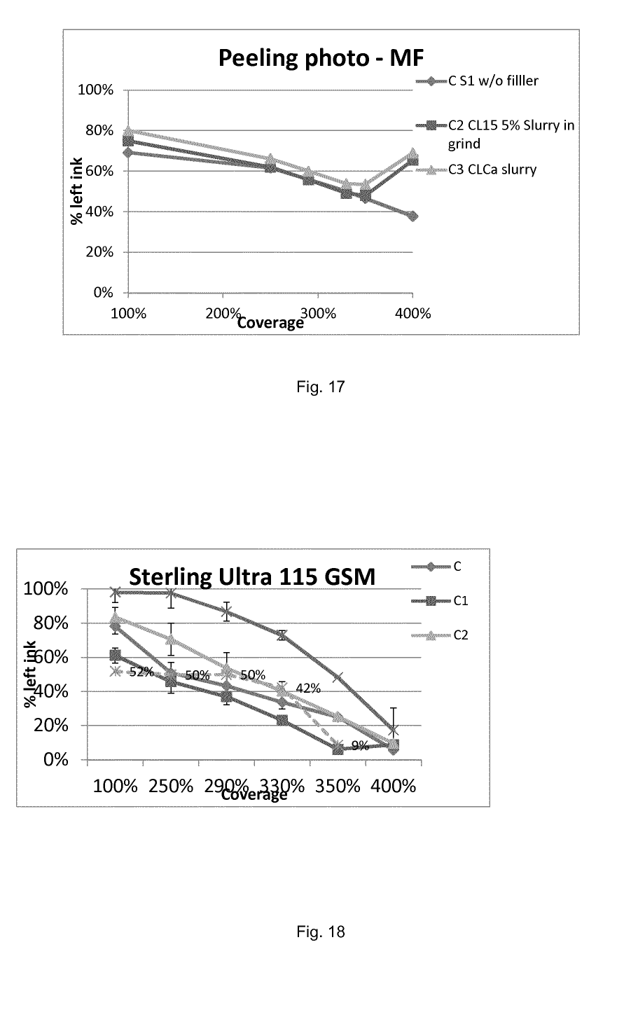

Results are shown in FIGS. 15 to 17, respectively, for the inks on the following print media: Perigord, EuroArt, and MultiFine. In these Figures, C1 is termed “C S1”.

While the liquid electrophotographic ink and related methods and print substrates, have been described with reference to certain examples, those skilled in the art will appreciate that various modifications, changes, omissions, and substitutions can be made without departing from the spirit of the disclosure. It is intended, therefore, that the methods, print substrates, printing systems and related aspects be limited by the scope of the following claims. The features of any dependent claim may be combined with the features of any of the independent claims or other dependent claims.

1. A liquid electrophotographic ink composition comprising clay platelets.

2. A liquid electrophotographic ink composition according to claim 1, wherein at least some of the clay platelets have a maximum dimension of about 50 μm or less.

3. A liquid electrophotographic ink composition according to claim 1, wherein at least some of the clay platelets have a maximum dimension of about 10 μm or less.

4. A liquid electrophotographic ink composition according to claim 1, wherein the clay platelets comprise a clay material selected from montmorillonite, kaolinite, halloysite, illite, vermiculite, talc, palygorskite and pyrophyllite.

5. A liquid electrophotographic ink composition according to claim 4, wherein the clay material has been modified with a quaternary ammonium salt.

6. A liquid electrophotographic ink composition according to claim 5, wherein the quaternary ammonium salt has a group comprising a C10 to C20 alkyl or alkylene group.

7. A liquid electrophotographic ink composition according to claim 1, wherein the clay platelets constitute from about 1 wt % to about 10 wt % of the solids of the liquid electrophotographic ink composition.

8. A liquid electrophotographic ink composition according to claim 1, wherein the clay platelets constitute from about 3 wt % to about 7 wt % of the solids of the liquid electrophotographic ink composition.

9. A liquid electrophotographic ink composition according to claim 1, wherein the ink comprises particles comprising a resin having acidic side chains.

10. A liquid electrophotographic ink composition according to claim 1, wherein the ink comprises particles comprising a resin comprising a polymer selected from (i) ethylene or propylene acrylic acid co-polymers and (ii) ethylene or propylene methacrylic acid co-polymers.

11. A method for electrophotographic printing comprising
forming a latent electrostatic image on a surface;
contacting the surface with a liquid electrophotographic ink composition comprising clay platelets to form a developed toner image on the surface, and transferring the toner image to a print substrate.

12. A method according to claim 11, wherein clay platelets comprise a clay material selected from montmorillonite, kaolinite, halloysite, illite, vermiculite, talc, palygorskite and pyrophyllite.

13. A method according to claim 12, wherein the clay material has been modified with a quaternary ammonium salt.

14. A method according to claim 13, wherein the quaternary ammonium salt has a group comprising a C10 to C20 alkyl or alkylene group.

15. A print substrate having printed thereon an ink comprising a resin having acidic side groups and clay platelets.
